(19) United States
(12) Patent Application Publication
(10) Pub. No.: US 2021/0033882 A1
(43) Pub. Date: Feb. 4, 2021

(54) EYEGLASS CLIP

(71) Applicant: CKMC ENTERPRISES, LTD., North Richland Hills, TX (US)

(72) Inventors: Karen Lopez McWilliams, Fort Worth, TX (US); Chalmer McWilliams, Fort Worth, TX (US); Huy Nguyen, Alpine, UT (US)

(21) Appl. No.: 16/942,111

(22) Filed: Jul. 29, 2020

Related U.S. Application Data
(60) Provisional application No. 62/881,536, filed on Aug. 1, 2019.

(51) Int. Cl. G02C 3/00; F16B 2/24

(52) U.S. Cl. CPC G02C 3/00; F16B 2/245

(57) ABSTRACT

An eyeglass clip includes a first arm including a distal portion; a proximal portion; and a contact portion interconnecting the distal portion and the proximal portion, wherein a first bend is defined between the proximal portion and the contact portion and a second bend is defined between the distal portion and the contact portion; a second arm adjacent to the first arm, the second arm defining a free end, the second arm being planar wherein the free end of the first arm and the free end of the second arm diverge from one another; and a return bend connecting the first arm and the second arm at an end opposite to the free end of each of the first arm and second arm, the return bend defining an eyelet between the first arm and the second arm. The contact portion of the first arm is parallel to the second arm.

### CROSS-REFERENCE TO RELATED APPLICATION

The present application claims the benefit of and priority to U.S. Provisional Patent Application Ser. No. 62/881,536, filed on Aug. 1, 2019, the entire content of which is incorporated by reference herein.

### BACKGROUND

The present disclosure relates to accessories for eyewear (e.g., eyeglasses, sunglasses, sunglasses, etc.), and more specifically to a clip for securing to the eyewear for affixing the eyewear to clothing and the like.

Eyeglass users have a universal problem—dropping, misplacing and damaging eyeglasses. Now there is a universal solution to keep eyeglasses near and in place—the EYE-TIE™ eyeglass clip. Gone are the days of simply affixing eyeglasses to clothing, handbags or placing them on top of your head in hopes that it will not result in fallen, broken or lost glasses. The EYE-TIE™ eyeglass clip conveniently allows users to secure their eyewear when not in use.

### SUMMARY

Accordingly, this disclosure details implementations for a clip that provides increased holding force at selected portions thereof thereby enabling a user to further connect the clip to a set of eyeglasses and ultimately connect the connected clip-eyeglasses to a portion of a garment or the like.

According to an aspect of the present disclosure, an eyeglass clip is provided and includes a first arm defining a free end. The first arm includes a distal portion defining a distal tip at the free end of the first arm; a proximal portion; and a contact portion interconnecting the distal portion and the proximal portion, wherein a first bend is defined between the proximal portion and the contact portion and a second bend is defined between the distal portion and the contact portion. The eyeglass clip further includes a second arm adjacent to the first arm and extending parallel therewith, the second arm defining a free end, the second arm being planar wherein the free end of the first arm and the free end of the second arm diverge from one another. The eyeglass clip also includes a return bend connecting the first arm and the second arm at an end opposite to the free end of each of the first arm and second arm, the return bend defining an eyelet between the first arm and the second arm. The contact portion of the first arm is parallel to the second arm.

The eyeglass clip may define a length and a width, and wherein the eyeglass clip defines a length to width ratio of 10:1.

The eyeglass clip may have a length of 48 mm.

The contact portion of the first arm may be in contact with the second arm.

The diverging free ends of the first arm and the second arm my define an opening for the eyeglass clip, wherein the opening is tapered at an angle of 7 degrees.

The eyelet defined by the return bend may have a tear-drop configuration with a taper extending toward the contact portion. The taper of the eyelet may have an angle of 7 degrees.

The eyeglass clip may be fabricated from a resilient material. The resilient material may be selected from the group consisting of spring steel, 304 steel, c45 steel, and nitinol.

The eyeglass clip may further include an adhesive disposed along the second arm, wherein the adhesive is located on a side of the second arm opposite to the first arm.

The first arm may be shorter than the second arm.

According to a further aspect of the present disclosure, an eyeglass clip is provided and includes a C-shape return bend including a resilient body, the resilient body defining a first end and a second end; a first arm extending from the first end of the return bend, wherein the first arm has a concave profile; and a second arm extending away from the second end of the return bend, wherein the second arm has a planar profile, wherein a nadir of the concave profile of the first arm is in close proximity to the second arm at a mid-point of the first arm.

The first arm may include a distal portion defining a distal tip at the free end of the first arm; a proximal portion; and a contact portion interconnecting the distal portion and the proximal portion, wherein a first bend is defined between the proximal portion and the contact portion and a second bend is defined between the distal portion and the contact portion, wherein the contact portion of the first arm is parallel to the second arm.

The second arm may extend parallel with the first arm, the second arm defining a free end, wherein the free end of the first arm and the free end of the second arm diverge from one another.

The return bend may define an eyelet between the first arm and the second arm.

The eyeglass clip may define a length and a width, and wherein the eyeglass clip may define a length to width ratio of 10:1. The length may be 48 mm.

The diverging free ends of the first arm and the second arm may define an opening for the eyeglass clip, wherein the opening is tapered at an angle of 7 degrees, and wherein the eyelet defined by the return bend has a tear-drop configuration with a taper extending toward the contact portion, wherein the taper of the eyelet has an angle of 7 degrees.

The resilient material may be selected from the group consisting of spring steel, 304 steel, c45 steel, and nitinol.

The eyeglass clip may further include an adhesive disposed along the second arm, wherein the adhesive is located on a side of the second arm opposite to the first arm.

Other aspects, features, and advantages will be apparent from the description, the drawings, and the claims that follow.

### BRIEF DESCRIPTION OF DRAWINGS

The accompanying drawings, which are incorporated in and constitute a part of this specification, illustrate embodiments of the disclosure and, together with a general description of the disclosure given above and the detailed description given below, serve to explain the principles of the disclosure, wherein:

FIG. 1 is a perspective top view of an eyeglass clip in accordance with this disclosure;

FIG. 2 is a left side view of the eyeglass clip shown in FIG. 1;

FIG. 3 is a top view of the eyeglass clip shown in FIG. 1;

FIG. 4 is a front view of the eyeglass clip shown in FIG. 1;

FIG. 5 is a back view of the eyeglass clip shown in FIG. 1;

FIG. 6 is a perspective top view of the eyeglass clip shown in FIG. 1 connected to a pair of eyeglasses;

FIG. 7 is a perspective top view of an alternative embodiment in accordance with this disclosure for the Eyeglass clip shown in FIG. 1;

FIG. 8 is a left side view of the eyeglass clip shown in FIG. 7;

FIG. 9 is a top view of the eyeglass clip shown in FIG. 7;

FIG. 10 is a front view of the eyeglass clip shown in FIG. 7;

FIG. 11 is a back view of the eyeglass clip shown in FIG. 7;

FIG. 12 is a perspective top view of the eyeglass clip shown in FIG. 7 connected to a pair of eyeglasses; and

FIG. 13 is a perspective view of an eyeglass clip according to still a further embodiment of the present disclosure.

### DETAILED DESCRIPTION

The EYE-TIE™ eyeglass clip (hereinafter, “eyeglass clip”) is designed to be compatible with most eyewear on the market and can be applied to either left or right-side eyeglass temples. Its design is uniquely simple to install and easy to use while also providing a lasting experience with its durable and reliable design.

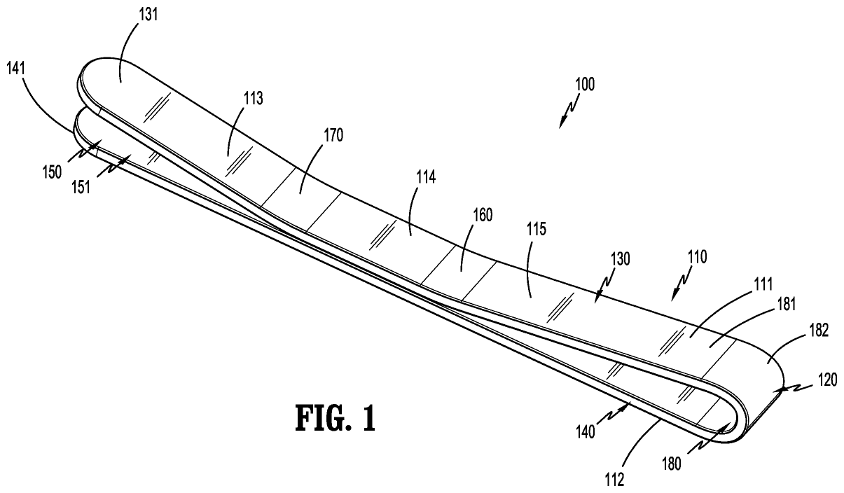

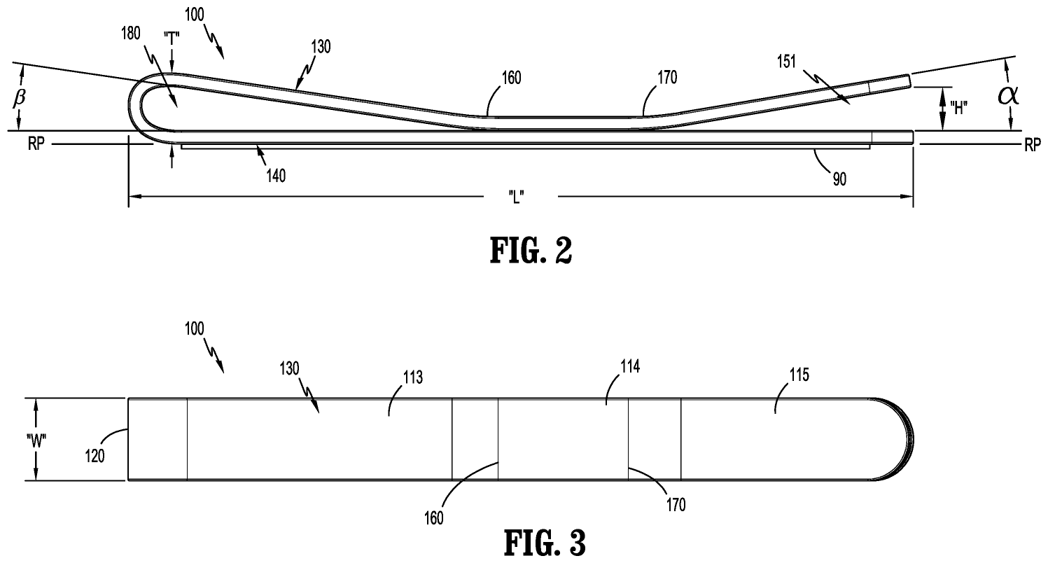

With brief reference to FIGS. 1-6, an eyeglass clip 100 is shown including a single frame or unibody configuration, which may improve rigidity and reduce weight in comparison to more traditional eyeglass clips. For example, the eyeglass clip 100 includes a body 110 having a body top portion 111 and a body bottom portion 112. Generally, the body 110 is configured to include a shape that forms an initial return bend portion or return bend 120 interconnecting body top portion 111 and body bottom portion 112. Further, the body 110 can be configured such that body top portion 111 is a first arm 130, body bottom portion 112 is a second arm 140, and a first opening 150 is defined between the first arm 130 and the second arm 140. The first arm 130 and the second arm 140 of body 110 define a corresponding free end generally labeled as first free end 131 (associated with the first arm 130) and second free end 141 (associated with the second arm 140). In selected embodiments, the second arm 140 of the body 110 may define a reference plane “RP” (FIG. 2).

The first arm 130 may have a substantially concave profile while the second arm 140 may have a substantially planar profile, wherein a nadir of the concave profile of the first arm 130 is in contact with or in close proximity to the second arm 140.

In embodiments, the body 110 is configured to (but not limited to) define a length “L” (FIG. 2) of about 48.0 mm after the return bend 120 is formed (the length of the clip 100 is about 101.0 mm before bending), a thickness “T” of about 0.80 mm (FIG. 2), and a width “W” of about 5.0 mm (FIG. 3). It is envisioned that the thickness “T” may be constant through all the body 110. Still in embodiments, the length “L” of the eyeglass clip 100 (after bending) may vary depending on two aspects, one, the total length of the body 110 (before bending), and two, the type of application. In selected embodiments, the desired length and surface area for the eyeglass clip 100 (after bending) may be selected based on the length and surface area of an eyeglass temple “TE” (FIG. 6) of an eyeglass wear piece “EW” (e.g., the length of an eyeglass temple is generally about 5.5 inches or 14 cm). In selected embodiments, the body 110, and more specifically, the second arm 140, is configured to include a surface area of about 240 mm² where the surface area is the area of contact of second arm 140 with eyeglass temple “TE”. In accordance with the present disclosure, eyeglass clip 100 may have a length “L” to width “W” ratio of about 50:5 or 10:1.

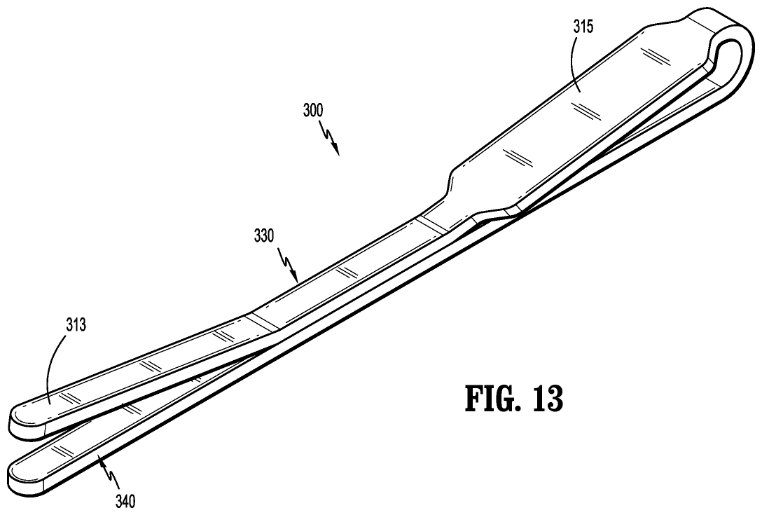

In an embodiment, for use with eyeglass wear pieces “EW” having relatively narrower eyeglass temples “TE”, it is contemplated that the eyeglass clip 100 may have a width “W” of about 1.70-2.0 mm along an entire length “L” thereof for both the first arm 130 and the second arm 140, or, in a further embodiment, as illustrated in FIG. 13, an eyeglass clip 300 may have a width “W” of about 1.70-2.0 mm along an entire length “L” of the second arm 340, and along a length of only the distal portion 313 of the first arm 330 (wherein the proximal portion 315 of the first arm 330 may have a width “W” of about 4.0-5.0 mm).

In selected embodiments, the body 110 and/or the eyeglass clips 100/200 described herein, may be fabricated using metal, such as, stainless spring steel, 304 stainless steel, 306 stainless steel, or other suitable materials having material abilities such as good holding strength, shape retention, resilience, stability in use, and a long life-cycle (e.g., plastic, resin, wood, bamboo, acrylic, nitinol, etc.). In one embodiment, the body 110 and/or the eyeglass clips 100/200 described herein, may be fabricated from steel number 45 (e.g., c45 steel) comprising 0.42-0.50% carbon (C), 0.17-0.37% silicon (Si), 0.50-0.80% manganese (Mn), <0.25% chromium (Cr), <0.30% nickel (Ni), and <0.35% copper (Cu).

During manufacturing the body 110 may include a surface finish selected from metal plating, brushed metal, buff polishing, metal grinding, metal vibratory, sand blasting, power coating, hot blackening u others. Further, the body 110 may include a coating applied before, after, or during the surface finishing process (e.g., a coat of paint).

The return bend 120 of the eyeglass clip 100 is generally disposed or formed at about one-half of the total length (e.g., mid-point) of the body 110 (before bending). Moreover, after bending the body 110, the first arm 130, the second arm 140, and the first opening 150 are defined, the first arm 130 and the second arm 140 are arranged to overlap one another. The return bend 120 of the eyeglass clip 100 is resilient and includes generally a C-shape, U-shape, or a teardrop configuration. The return bend 120 is disposed opposite to the opening 150.

In embodiments, the first opening 150 (FIG. 2) of body 110 may further include a tapered portion or first opening tapered portion 15. Generally, the first opening 150 is configured to receive a piece of garment there through. While in use, a user may slide a piece of garment between the first arm 130 and the second arm 140 by inserting the piece of garment through the tapered portion 151 of the first opening 150. The first opening 150 is generally define at an end opposite to the return bend 120, the first opening 150 defines a distance or height “H” between the first arm 130 and the second arm 140. More specifically, the height “H” is the distance between the free ends 131 and 141 of the first and second arm 130 and 140. In selected embodiments, usually measured near the first opening 150, the height “H” measures about 2.0 mm.

Further, in embodiments the eyeglass clip 100 may include angular pitches or angles. In selected embodiments these angular pitches or angles may be associated with the above noted first opening 150 and the return bend 120. For example, the eyeglass clip 100 may include angular pitches or angles alpha “α” and beta “β”. Generally, the angle alpha “α” is associated with the opening 150 and is an angle measured between a longitudinal axis of the second arm 140 and a longitudinal axis of a distal portion of the first arm 130. In embodiments, the angle alpha “α” measures about 7 degrees. Further in embodiments, the configuration of the angle beta “β” may substantially-mirror the configuration of the angle alpha “α” and may be associated with the return bend 120. The angle beta “β” is associated with the return bend 120 and is an angle measured between the longitudinal axis of the second arm 140 and a longitudinal axis of a proximal portion of the first arm 130.

Still with reference to FIGS. 1-6, in addition to the return bend 120, the body 110 of the eyeglass clip 100 may include additional bends. In embodiments, these bends may be associated with the above note angles alpha “α” and beta “β”. In exemplary embodiments, one arm, selected from the first arm 130 or the second arm 140 (of the eyeglass clip 100), may include at least two additional bends or deflections formed along a length thereof. For example, as best seen in FIG. 2, the first arm 130 includes a first bend 160 and a second bend 170 formed along a length thereof. As seen in FIG. 3, the bends 160 and 170 further define along the first arm 130 an initial or distal portion 113, a central or contact portion 114, and an end or proximal portion 115. The distal portion 113 is inclined and may be defined by the above noted angle alpha “α”. The contact portion 114 is substantially parallel to the second arm 140 or reference plane “RP” thereof. Moreover, the proximal portion 115 is inclined in such a way that may mirror the inclination of the distal portion 113. In embodiments, the angle of inclination of the distal portion 113 may be less than 10 degrees (e.g., about 7 degrees, as noted above with reference to the first opening 150) and the angle of inclination for the proximal portion 115 may be less than 180 degrees (e.g., about 173 degrees measured from the longitudinal axis 142 in a clockwise direction towards the first arm 130, as illustrated in FIG. 2).

Moreover, and specifically with respect to the first arm 130, the contact portion 114 of the first arm 130 is disposed between the first bend 160 and second bend 170. The contact portion 114 enables planar contact between the first arm 130 and the second arm 140 (before a piece of garment is received by the eyeglass clip 100) at about ½ of the length “L” (e.g., mid-point). Furthermore, in embodiments, first arm 130 may be configured to include a contact surface area of about 25-40 mm² where the surface area is the area of contact between the first arm 130 and the second arm 140. Further, the first arm 130 is configured such that the surface area of the first arm 130 is the contact portion 114.

Moreover, with respect to the second arm 140. The second arm 140 is generally flat, elongated, and configured for attachment. In embodiments, the second arm 140 is further configure for attachment or connection to a piece of eyewear such, as eyeglasses, sunglasses, or the like, as seen in FIG. 6. Specifically, eyeglass clip 100 includes a means of connection, for example, an adhesive strip 90 (as seen in FIGS. 1, 2, and 4-6) provided on an outer surface of the second arm 140 or configured for attachment to thereto. Adhesive strip 90 will be describe more in detain further.

In embodiments, the eyeglass clip 100 may further include a second opening. More specifically, when the first arm 130 and the second arm 140 are in contact with one another, a second opening or eyelet opening 180 is formed between the first arm 130 and the second arm 140 (opposite the first opening 150) and enclosed by return bend 120. The eyelet opening 180 includes a tapered portion 181, and a C-shaped portion 182, where the above noted angle beta “β” may define the degree of taper of tapered portion 181 (FIG. 2).

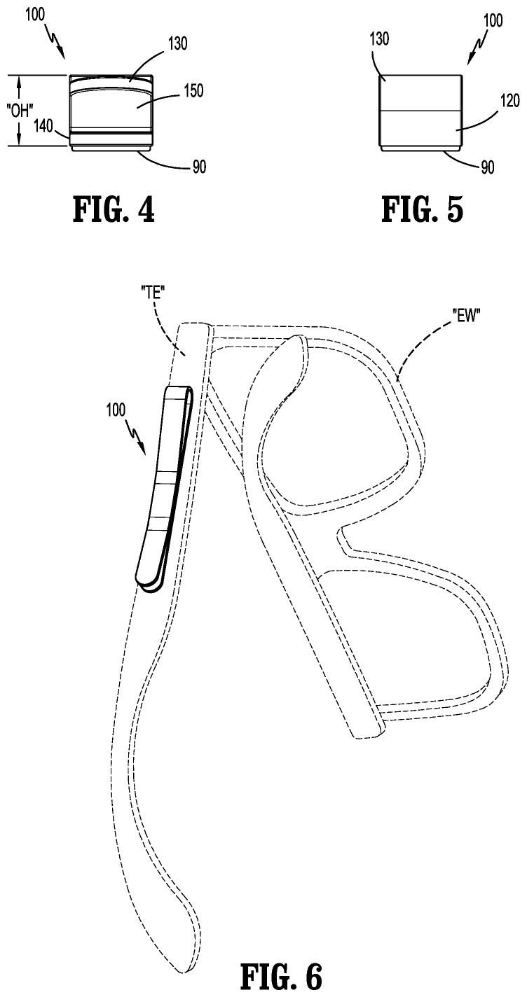

Still when the first arm 130 and the second arm 140 are in contact and after the formation of the bends 120, 160, and 170; the eyeglass clip 100 defines an overall height “OH” (FIG. 4). The overall height “OH” is defined as a distance between the first arm 130 and the second arm 140. Specifically, “OH” is a distance measured from an outer surface (of the first arm 130) and an outer surface (of the second arm 140), which can be measured at the return bend 120, as seen in FIG. 4. While in use, the overall height “OH” may vary. In exemplary embodiments, the overall height “OH” may be less than 10.0 mm (e.g., approximately 5.0 mm). In selected embodiments, the values for the overall height “OH” and the height “H” may be close in value (e.g., the value for “OH” may be of about 4.5 mm and the value for “H” may be of about 4.0 mm).

It is contemplated that all the above noted values may vary and are not limited by the above noted values. These values and other above noted measurements (e.g., exemplary measurements noted above) are primary used as exemplary values and measurements used as an aid to the description of the above, noted structures and elements.

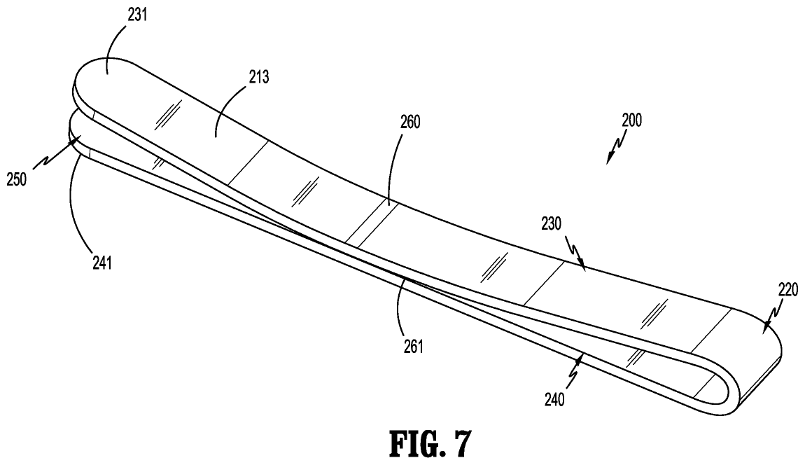

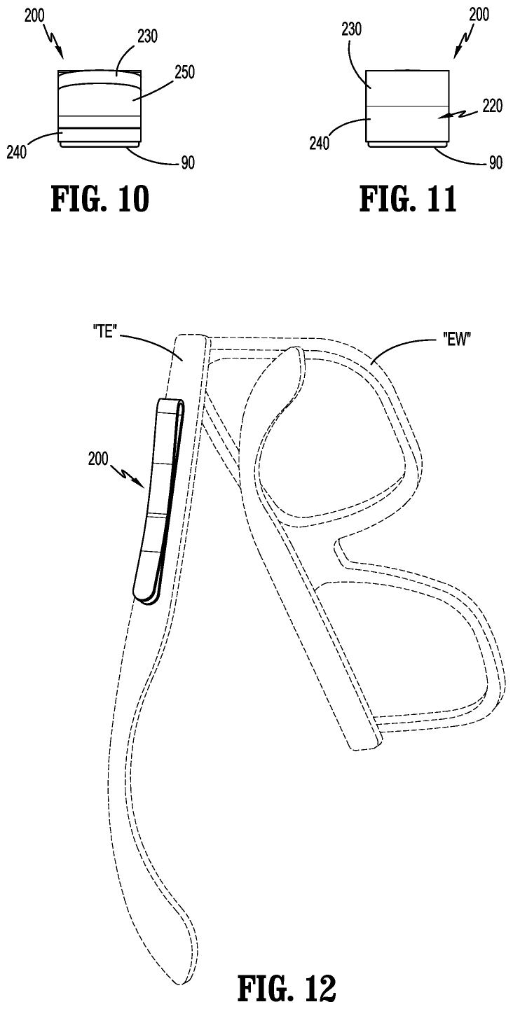

Now turning to FIGS. 7-12, an alternative embodiment associated with the eyeglass clip 100 is presented. The alternative embodiment is generally labeled eyeglass clip 200, the eyeglass clip 200 is presented including a substantially similar configuration to the eyeglass clip 100. The eyeglass clip 200 includes a body 210, a return bend 220, a first arm 230, a second arm 240, a first opening 250, a first bend 260, an eyelet opening 280.

The eyeglass clip 200 is substantially similar to the eyeglass clip 100, with the eyeglass clip 200 including variations. In an exemplary variation, in contrast to the two bends 160 and 170 of the eyeglass 100, one variation may include having the first arm 230 of the eyeglass clip 200 configured to include only one bend, such as a first bend 260. The first bend 260 is the portion of contact between the first arm 230 and the second arm 240 of the eyeglass clip 200. The first bend 260 does not include a substantially flat configuration (in contrast to the substantially flat configuration of contact portion 114 of eyeglass clip 100 where the contact portion is disposed along arm 130). As best seen in FIG. 9, the first bend 260 is generally disposed between an initial or distal portion 213 and an end or proximal portion 215 of the first arm 230.

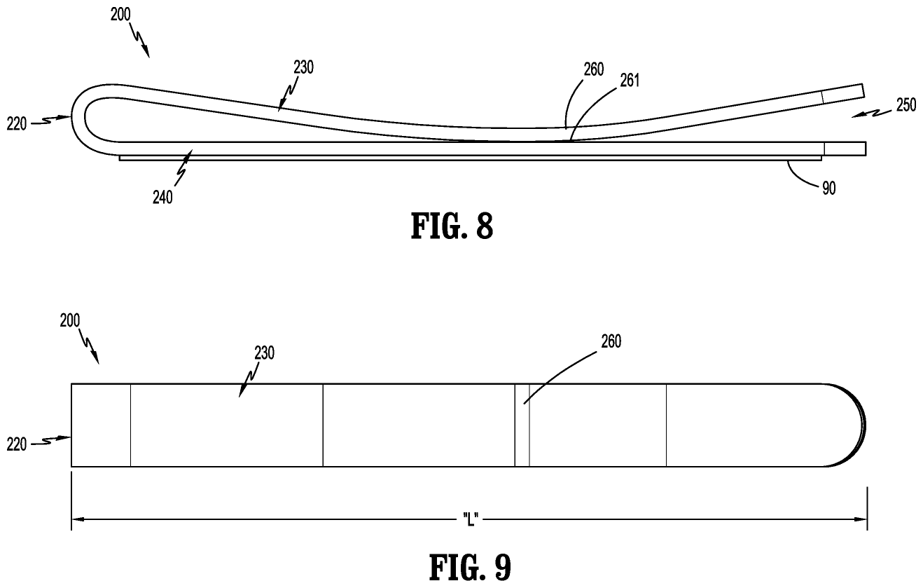

In selected embodiments, the eyeglass clips 200 may be presented including the first bend 260 of the first arm 230 as a contact portion configured to operably engage with the second arm 240 or a portion thereof. As presented in the exemplary embodiment in FIG. 8, the bend 260 is generally disposed about ½ of a length L of the eyeglass clip 200 and includes a selected portion of contact or crest 261. The crest 261 is disposed between angles “α” and “β” (which are generally similar and mirrored), of the eyeglass clip 200.

Similar to the second arm 140 of the eyeglass clip 100, the second arm 240 of eyeglass clip 200 is generally flat, elongated, and configured for attachment. The second arm 240 is disposed adjacent first arm 230. In embodiments, the second arm 240 is further configured for attachment or connection to a piece of eyewear such, as eyeglasses, sunglasses, or the like, as seen in FIG. 12. Specifically, eyeglass clip 200 includes a means of connection, for example, the above noted adhesive strip 90 provided on an outer surface of the second arm 240 or configured for attachment thereto.

Now referring to FIGS. 14-15, an adhesive strip 90 may be connected to an eyeglass clip 100 or 200. In general, the adhesive strip 90 may be configured to include a shape similar to second arms 140, 240 arm of eyeglass clips 100, 200 or have a rectangular shape. In embodiments, it may be desired to configure the adhesive strip 90 in such a way so it maximizes the adhesion footprint of the eyeglass clip while avoiding extension of the adhesive strip 90 outside of a contact surface of second arm 140, 240 of eyeglass clip 100, 200.

The adhesive strip 90 includes two opposed surfaces, a temple-connecting surface and an arm-clip-connecting surface (not shown). The temple-connecting surface generally connects or contacts to the exterior surface of a selected eyewear temple (FIGS. 6 and 12) and the arm clip-connecting surface (not show) connects to or contacts an exterior surface of second arm 140, 240 of eyeglass clip 100, 200.

In embodiments, the adhesive strip 90 may be a double-sided tape including two sticky surfaces or as single-sided tape with one sticky surface. In a double-sided tape configuration, the adhesive strip 90 may be a standalone adhesive strip 90 including two sticky surfaces one configured for connection to a selected eyeglass clip and the other surface (such as the temple-connecting surface) may be covered by or connected to a peeling substrate. For example, the temple-connecting surface of the adhesive strip 90 may be connected to second arms 140 or 240 of eyeglass clips 100 or 200, as seen in FIG. 15. In a single-sided tape configuration, the adhesive strip 90 includes on free sticky surface (such as the temple-connecting surface) and the other remaining surface may be pre-connected to eyeglass clip 100 or 200 via an adhesive such as glue or the like.

In selected embodiments it may be desired to include at least one peeling substrate associated to the adhesive strip 90 to prevent any unwanted adhesion. The peeling substrate may connect the second arm 140, 240 of the eyeglass clips 100 or 200 via the adhesive strip 90. Specifically, the peeling substrate is configured to connect to a sticky surface of the adhesive strip 90 (generally the temple-connecting surface) as see in FIG. 15. In other words, the adhesive strip 90 can be disposed in a sandwich like configuration between the peeling substrate and arm 140 or arm 240 of the eyeglass clip 100, 200.

In addition, the eyeglass clips 100 or 200 can be further received or enclosed in a wrap or a package. The package is an exemplary wrap or packet configured to enclose the eyeglass clip 100 or 200 or a plurality thereof. The package may include a front portion and a back portion. The front portion and the back portion of the package are generally opposed one to another. Further, the package may include at least one at least one adhesive strip 90.

In selected configurations for the package and the eyeglass clips 100 and 200, the package may include at least one eyeglass clip 100 and/or 200 and a corresponding adhesive strip 90 optionally attached or detached to the at least one eyeglass clip 100 and/or 200. In other words, the package can include the adhesive strip 90 pre-attached to the at least one eyeglass clip 100 and/or 200 prior sealing of the package. On the other hand, for selected embodiments, it may be desired to have the adhesive strip 90 configured in such a way that a user may have the option of attaching the adhesive strip 90 to a portion of an eyeglass clip after opening the package.

For configurations including more than one eyeglass clip in the package, a user may select an eyeglass clip 100 or 200 (hereinafter “the selected eyeglass clip”) from a set of eyeglass clips enclosed in the package. After selecting the selected eyeglass clip, the user can connect the selected eyeglass clip to a temple “TE” of eyeglass wear piece “EW”. Connecting the selected eyeglass clip to the temple “TE” may be done by following connecting instructions (generally noted along the package). For example, the selected eyeglass clip is configured including the adhesive 90 pre-attached to an arm of the selected eyeglass piece prior packaging the selected eyeglass piece into the package. The adhesive 90 includes a peeling strip (as described above) attached thereto. While in use as noted in the package, the user may disconnect of separate the peeling substrate from the adhesive 90; reveal the temple-connecting surface; determine the placement of the selected eyeglass clip 100, 200 on an eyewear's temple “TE”; connect the temple-connecting surface to the eyewear's temple “TE”; firmly hold and press the selected eyeglass clip 100, 200 against the eyewear's temple “TE” for 60 seconds; and clip the selected eyeglass clip 100, 200 (now connected to the eyeglass temple “TE”) to a piece of garment by sliding a portion of the piece of garment between the arms of the selected eyeglass clip 100, 200. More specifically, the user may slide the selected piece of garment through the first opening (e.g., first opening 150 for an eyeglass clip 100 or first opening 250 for an eyeglass clip 200) of the selected eyeglass clip while sandwiching the piece of garment between the arms of the selected eyeglass clip 100, 200.

In embodiments, besides the above-mentioned adhesive strip 90 or in addition to, other forms of attaching elements may be contemplated, including, and not limited to, glue, hook and loop fasteners, string, rubber bands, twist/zip ties, tubular sleeves, etc.

With reference to the above-mentioned piece of garment, a preferred piece of garment for connecting one the selected eyeglass clip to may be selected from a T-shirt, business shirt, blouse, buttonholes, pants, pocket, purse, briefcase, or blazer pocket. Further, the adhesive 90 may be carefully removed or disconnected from an eyeglass temple “T” via dish soap and water.

Persons skilled in the art will understand that the structures and methods specifically described herein associated with the above described eyeglass clips and illustrated in the accompanying figures are non-limiting exemplary embodiments, and that the description, disclosure, and figures should be construed merely as exemplary of particular embodiments. It is to be understood, therefore, that the present disclosure is not limited to the precise embodiments described, and that various other changes and modifications may be affected by one skilled in the art without departing from the scope or spirit of the disclosure. Additionally, it is envisioned that the elements and features illustrated or described in connection with one exemplary embodiment may be combined with the elements and features of another without departing from the scope of the present disclosure, and that such modifications and variations are also intended to be included within the scope of the present disclosure. Indeed, any combination of any of the presently disclosed elements and features is within the scope of the present disclosure. Accordingly, the subject matter of the present disclosure is not to be limited by what has been particularly shown and described.

1. An eyeglass clip, the eyeglass clip comprising:
a first arm defining a free end, the first arm including:
a distal portion defining a distal tip at the free end of the first arm;
a proximal portion; and
a contact portion interconnecting the distal portion and the proximal portion, wherein a first bend is defined between the proximal portion and the contact portion and a second bend is defined between the distal portion and the contact portion;
a second arm adjacent to the first arm and extending parallel therewith, the second arm defining a free end, the second arm being planar wherein the free end of the first arm and the free end of the second arm diverge from one another; and
a return bend connecting the first arm and the second arm at an end opposite to the free end of each of the first arm and second arm, the return bend defining an eyelet between the first arm and the second arm,
wherein the contact portion of the first arm is parallel to the second arm.

2. The eyeglass clip of claim 1, wherein the eyeglass clip defines a length and a width, and wherein the eyeglass clip defines a length to width ratio of 10:1.

3. The eyeglass clip of claim 2, wherein the length is 48 mm.

4. The eyeglass clip of claim 3, wherein the contact portion of the first arm is in contact with the second arm.

5. The eyeglass clip of claim 4, wherein the diverging free ends of the first arm and the second arm define an opening for the eyeglass clip, wherein the opening is tapered at an angle of 7 degrees.

6. The eyeglass clip of claim 5, wherein the eyelet defined by the return bend has a tear-drop configuration with a taper extending toward the contact portion.

7. The eyeglass clip of claim 6, wherein the taper of the eyelet has an angle of 7 degrees.

8. The eyeglass clip of claim 7, wherein the eyeglass clip is fabricated from a resilient material.

9. The eyeglass clip of claim 8, wherein the resilient material is selected from the group consisting of spring steel, 304 steel, c45 steel, and nitinol.

10. The eyeglass clip of claim 9, further comprising an adhesive disposed along the second arm, wherein the adhesive is located on a side of the second arm opposite to the first arm.

11. The eyeglass clip of claim 10, wherein the first arm is shorter than the second arm.

12. An eyeglass clip, comprising:
a C-shape return bend including a resilient body, the resilient body defining a first end and a second end;
a first arm extending from the first end of the return bend, wherein the first arm has a concave profile; and
a second arm extending away from the second end of the return bend, wherein the second arm has a planar profile, wherein a nadir of the concave profile of the first arm is in close proximity to the second arm at a mid-point of the first arm.

13. The eyeglass clip of claim 12, wherein the first arm includes:
a distal portion defining a distal tip at the free end of the first arm;
a proximal portion; and
a contact portion interconnecting the distal portion and the proximal portion, wherein a first bend is defined between the proximal portion and the contact portion and a second bend is defined between the distal portion and the contact portion, wherein the contact portion of the first arm is parallel to the second arm.

14. The eyeglass clip of claim 13, wherein the second arm extends parallel with the first arm, the second arm defining a free end, wherein the free end of the first arm and the free end of the second arm diverge from one another.

15. The eyeglass clip of claim 14, wherein the return bend defines an eyelet between the first arm and the second arm.

16. The eyeglass clip of claim 15, wherein the eyeglass clip defines a length and a width, and wherein the eyeglass clip defines a length to width ratio of 10:1.

17. The eyeglass clip of claim 16, wherein the length is 48 mm.

18. The eyeglass clip of claim 17, wherein the diverging free ends of the first arm and the second arm define an opening for the eyeglass clip, wherein the opening is tapered at an angle of 7 degrees, and wherein the eyelet defined by the return bend has a tear-drop configuration with a taper extending toward the contact portion, wherein the taper of the eyelet has an angle of 7 degrees.

19. The eyeglass clip of claim 18, wherein the resilient material is selected from the group consisting of spring steel, 304 steel, c45 steel, and nitinol.

20. The eyeglass clip of claim 19, further comprising an adhesive disposed along the second arm, wherein the adhesive is located on a side of the second arm opposite to the first arm.
